(19) United States
(12) Patent Application Publication
(10) Pub. No.: US 2022/0245550 A1
(43) Pub. Date: Aug. 4, 2022

(54) METHOD, SERVER, AND TERMINAL DEVICE FOR SUPPORTING CENTRALIZED MANAGEMENT OF BATTERIES INSTALLED IN MULTIPLE VEHICLES

(71) Applicant: Mazda Motor Corporation, Hiroshima (JP)

(72) Inventor: Hitoshi NAKATA, Irvine, CA (US)

(73) Assignee: Mazda Motor Corporation, Hiroshima (JP)

(21) Appl. No.: 17/560,262

(22) Filed: Dec. 23, 2021

(30) Foreign Application Priority Data
Feb. 2, 2021 (JP) 2021-014780

(51) Int. Cl. G06Q 10/06; B60L 58/10; B60L 53/30; B60L 53/35; B60L 53/65; B60L 53/66; G06Q 10/00

(52) U.S. Cl. CPC G06Q 10/06316; B60L 58/10; B60L 53/305; G06Q 10/20; B60L 53/65; B60L 53/66; B60L 53/35

(57) ABSTRACT

A method of supporting the centralized management of batteries of a plurality of vehicles. Vehicle information including vehicle identification information, vehicle position information, and battery voltage information is acquired from the vehicles. A plurality of sub-areas are set in a vehicle storage area. Vehicles in need of charging are extracted. A terminal device indicates first display that indicates decision information regarding the vehicles in need of charging in each of the plurality of sub-areas. The terminal device indicates second display that indicates vehicle identification information and vehicle position information regarding the vehicles in need of charging in a management sub-area when a predetermined operation is performed in the terminal device.

### CROSS-REFERENCE TO RELATED APPLICATION

The present application claims priority to Japanese application number 2021-014780 filed in the Japanese Patent Office on Feb. 2, 2021, the entire contents of both of which being incorporated herein by reference.

### TECHNICAL FIELD

The disclosed technique relates to a method, a server, and a terminal device that support the centralized management of batteries installed in a plurality of vehicles.

### BACKGROUND ART

There is disclosed a remote vehicle management system that relates to the disclosed technique and includes a vehicle, a server, and a mobile phone (patent document 1). In this remote vehicle management system, the owner of the vehicle sends a request email to the server by operating the mobile phone. This allows the owner to remotely manage the vehicle of the owner. Specifically, the confirmation of the vehicle position, the opening and closing of the door, and the charge of the battery can be performed by remote control.

### PRIOR ART DOCUMENTS

### Patent Documents

[Patent document 1] JP-A-2004-334862

### SUMMARY

### Problems to be Solved

Transportation ports, transportation companies, dealers, and the like have places in which many vehicles are stored. In such places, stored vehicles need to be maintained to keep the quality of the vehicles.

For example, the battery installed in a vehicle is reduced in voltage when left unattended. When the voltage of the battery is continuously low, the battery will irreversibly degrade. Accordingly, the battery needs to be managed so as to keep a voltage not less than a predetermined value by charging it regularly.

Accordingly, in such a place in which many vehicles are stored as described above, the voltages of the batteries installed in the stored vehicles are managed while the states of the stored vehicles are checked. That is, the vehicles in need of charging are selected from many stored vehicles. After that, the worker who performs management work goes to the places in which the vehicles are parked and finds the target vehicles. Then, the worker checks the states of the vehicles, such as the appearances of the vehicles. In addition, the worker charges the batteries.

For example, a transportation port has a vast space in which hundreds of vehicles are generally stored. Since a huge number of vehicles are stored, it is not easy to select the vehicles in need of charging from these vehicles. In addition, since the space is vast, it takes labor and time for the worker to go to the places in which the vehicles in need of charging are parked. Since many similar vehicles are parked, it is difficult for the worker to find the target vehicle.

Furthermore, it usually takes a long time to charge the battery. For example, when the battery is charged by driving the engine, it takes several hours until the voltage of the battery reaches an appropriate value. Accordingly, at present, the number of vehicles that can be managed by one worker is only a few a day.

In particular, the number of the electrical components installed in vehicles is expected to increase in the future. As the number of electrical components increases, the power consumption of stored vehicles also increases. Since the voltages of the batteries are likely to be reduced, the workload of this management probably increases.

Accordingly, there is a demand for a technique for reducing the work load by supporting the centralized management of the batteries installed the plurality of vehicles.

The remote vehicle management system described above can be applied to charge the batteries by remote control. However, the target of the remote vehicle management system described above is used by one vehicle of the owner. Accordingly, the owner who performs management only needs to manage the specific vehicle and battery. The owner who performs management is also familiar with the states of the vehicle and the battery, such as the model and the duration of use. Accordingly, the management is easy.

In contrast, in the case of the stored vehicles as described above, the number of target vehicles is large. Furthermore, the worker who performs management must target unspecified vehicles for which the worker does not know the states. Accordingly, the management is difficult.

Furthermore, when the engine is started by remote control from a distance to charge the battery, if a trouble occurs, it cannot be addressed immediately. Accordingly, the safety cannot be secured easily. In contrast, when the worker starts the engine while checking the vehicle directly, if a trouble occurs, it can be addressed immediately. Accordingly, the safety can be secured.

Accordingly, this specification discloses a technique for supporting the centralized management of the batteries installed in a plurality of vehicles.

### Means for Solving the Problems

The disclosed technique relates to a method of supporting centralized management of batteries installed in a plurality of vehicles parked in a predetermined vehicle storage area. This method includes a plurality of actions described below.

The method acquires, from the plurality of vehicles, vehicle information including vehicle identification information that enables identification of the vehicles, vehicle position information that enables identification of positions of the vehicles, and battery voltage information regarding voltages of the batteries. The method sets a plurality of sub-areas in the vehicle storage area. The method extracts at least one vehicle in need of charging, which is required to be charged, from the plurality of vehicles based on the battery voltage information. The method causes a predetermined portable terminal device to indicate first display that indicates decision information regarding the at least one vehicle in need of charging in each of the plurality of sub-areas. The method causes the terminal device to indicate second display that indicates the vehicle identification information and the vehicle position information regarding the at least one vehicle in need of charging in a management sub-area selected from the plurality of sub-areas when a predetermined operation is performed via the predetermined terminal device based on the first display.

That is, this method targets the plurality of vehicles parked in the predetermined vehicle storage area and supports the centralized management of the batteries installed in these vehicles. The method acquires the vehicle information from these vehicles. This identifies the positions and the characteristics of the vehicles, and the voltages of the batteries. Then, the method sets the plurality of sub-areas in the vehicle storage area. This subdivides the vehicle storage area.

The method extracts the at least one vehicle in need of charging, which is required to be charged, from the plurality of vehicles based on the battery voltage information. This identifies the vehicle for which the management of the battery is required. Then, the method causes the portable terminal device to indicate the first display that indicates the decision information regarding the at least one vehicle in need of charging in each of the sub-areas. This can determine the vehicle for which the management of the batteries is required for each of subdivided areas at any place. Accordingly, the management areas can be more appropriately narrowed to the areas (management sub-areas) to be managed. Since the management range is limited effectively, the work efficiency is improved.

Then, when the predetermined operation is performed in the terminal device based on the first display, the method causes the terminal device to indicate the second display that indicates the vehicle identification information and the vehicle position information regarding the at least one vehicle in need of charging in the management sub-area. This can indicate, for example, the second display near the site. Then, the method can identify the vehicle for which the management of the battery is required near the site based on the second display. Accordingly, the method can easily and appropriately find the vehicle for which management work is performed.

As described above, this method can effectively support the centralized management of the batteries installed in the plurality of vehicles. The work efficiency can be improved and the load of management work can be reduced.

In the method described above, the decision information may include a lowest voltage value of the battery among the at least one vehicle in need of charging that is parked in a single sub-area of the plurality of sub-areas, and the lowest voltage value may be indicated in each of the plurality of sub-areas of the first display.

As the voltage value of the battery is lower, irreversible degradation is advanced more easily. Accordingly, the lowest voltage value in the single sub-area is indicated in each of the sub-areas of the first display, whereby the priority of battery management work can be determined. This makes easier to select the management sub-area.

In the method described above, the decision information may include the number of the at least one vehicle in need of charging that is parked in the single sub-area of the plurality of sub-areas and the number of the at least one vehicle in need of charging may be indicated in each of the plurality of sub-areas of the first display.

When the number of the at least one vehicle in need of charging that is parked in the single sub-area is known, the amount of battery management work that needs to be performed in the sub-area can be predicted. Accordingly, the management sub-area can be selected easily.

In the method described above, when the terminal device indicates the second display, the terminal device may indicate, as a map, positions of the vehicles parked in the management sub-area and the position of the at least one vehicle in need of charging, and may indicate the vehicle identification information of a vehicle of the plurality of vehicles that is adjacent to the at least one vehicle in need of charging together with the vehicle identification information of the at least one vehicle in need of charging.

When the positions of the vehicles are illustrated as a map in the terminal device, the positions of the vehicles can be grasped visually. Accordingly, the at least one vehicle in need of charging can be easily identified. However, when a vehicle that is the same as the at least one vehicle in need of charging is present in the management sub-area, the at least one vehicle in need of charging cannot be identified by the appearance. Accordingly, the at least one vehicle in need of charging cannot be found from a distance. In contrast, when the vehicle adjacent to the at least one vehicle in need of charging can be identified together with the at least one vehicle in need of charging, the at least one vehicle in need of charging can be determined by the combination of these vehicles. Accordingly, the at least one vehicle in need of charging can be found even from a distance.

In the method described above, when the terminal device indicates the second display, the terminal device may indicate, as a map, the positions of the vehicles parked in the management sub-area and the position of the at least one vehicle in need of charging, terminal position information that enables identification of a position of the terminal device may be acquired from the terminal device, and, when a predetermined operation is performed in the terminal device, a route from the terminal device to the at least one vehicle in need of charging may be calculated based on the vehicle position information of the at least one vehicle in need of charging and the terminal position information, and the route is indicated in the second display.

When the route from the terminal device to the at least one vehicle in need of charging is indicated in the second display, the at least one vehicle in need of charging can be reached by following this route. Accordingly, the at least one vehicle in need of charging can be found easily.

In the method described above, the terminal device may indicate, as a map, positions of all the plurality of vehicles parked in the vehicle storage area, and at least one of the sub-areas may be set by operating the terminal device based on the indicated positions.

When the positions of all the plurality of vehicles parked in the vehicle storage area are illustrated as a map in the terminal device, all the vehicles possibly subject to management can be grasped visually. Accordingly, the appropriate setting of the sub-areas can be supported effectively.

In the method described above, a distance between each of all the plurality of vehicles parked in the vehicle storage area and a vehicle of the plurality of vehicles that is adjacent to each of all the plurality of vehicles parked in the vehicle storage area may be calculated, and at least one of the plurality of sub-areas may be set by identifying a group of vehicles of the plurality of vehicles stopped in a proximity state in which the distance is not more than a predetermined value.

Generally, the vehicles parked in the vehicle storage area are distributed in a close state in a plurality of locations. Accordingly, the sub-areas can be set appropriately by identifying the group of vehicles stopped in a proximity state in which the distance from an adjacent vehicle is not more than a predetermined value. Furthermore, the setting of sub-areas can be automated.

The disclosed technique also relates to a server that supports centralized management of batteries installed in a plurality of vehicles parked in a predetermined vehicle storage area.

The server includes an interface that enables predetermined vehicle information to be input and output from the plurality of vehicles and a predetermined portable terminal device via a network, a memory that stores the predetermined vehicle information and a predetermined control program, and a processor that processes the vehicle information by executing the control program.

The vehicle information includes vehicle storage area information that enables identification of a position of the vehicle storage area, vehicle identification information that enables identification of the plurality of vehicles, vehicle position information that enables identification of positions of the plurality of vehicles, and battery voltage information regarding voltages of the batteries. Then, the processor performs a plurality of pieces of processing described below in cooperation with the terminal device.

The plurality of pieces of processing include processing for acquiring the vehicle identification information, the vehicle position information, and the battery voltage information by requesting the plurality of vehicles to output the vehicle identification information, the vehicle position information, and the battery voltage information based on a command input from the terminal device, processing for setting a plurality of sub-areas in the vehicle storage area based on the vehicle storage area information, processing for extracting at least one vehicle in need of charging, which is required to be charged, from the plurality of vehicles based on the battery voltage information, processing for causing the terminal device to indicate first display that indicates decision information regarding the at least one vehicle in need of charging in each of the plurality of sub-areas, and processing for causing the terminal device to indicate second display that indicates the vehicle identification information and the vehicle position information regarding the at least one vehicle in need of charging in a management sub-area selected from the plurality of sub-areas when a predetermined command is input from the terminal device.

That is, this server is used in the support method described above. The server supports the centralized management of the batteries by performing the processing described above. Accordingly, as in the support method described above, this server can effectively support the centralized management of the batteries installed in the plurality of vehicles. The work efficiency can be improved and the load of management work can be reduced.

The disclosed technique also relates to a portable terminal device that supports centralized management of batteries installed in a plurality of vehicles parked in a predetermined vehicle storage area.

The terminal device includes an interface that enables predetermined vehicle information to be input to and output from a predetermined server via a network, a memory that stores the vehicle information and a predetermined control program, and a processor that processes the vehicle information by executing the control program, a display that indicates information processed by the processor, and a device capable of inputting a command for requesting the processor to perform predetermined processing.

The vehicle information includes vehicle storage area information that enables identification of a position of the vehicle storage area, vehicle identification information that enables identification of the plurality of vehicles, vehicle position information that enables identification of positions of the plurality of vehicles, and battery voltage information regarding voltages of the batteries. Then, the processor performs a plurality of pieces of processing described below in cooperation with the predetermined server.

The plurality of pieces of processing include processing for acquiring the vehicle identification information, the vehicle position information, and the battery voltage information by requesting the plurality of vehicles to output the vehicle identification information, the vehicle position information, and the battery voltage information based on the command input from the device, processing for setting a plurality of sub-areas in the vehicle storage area based on the vehicle storage area information, processing for extracting at least one vehicle in need of charging, which is required to be charged, from the plurality of vehicles based on the battery voltage information, processing for causing the display to indicate first display that indicates decision information regarding the at least one vehicle in need of charging in each of the plurality of sub-areas, and processing for causing the display to indicate second display that indicates the vehicle identification information and the vehicle position information regarding the at least one vehicle in need of charging in a management sub-area selected from the plurality of sub-areas when the device inputs a predetermined command based on the first display.

That is, this terminal device is used in the support method described above. The terminal device supports the centralized management of the batteries by performing the processing described above. Accordingly, as in the support method described above, this terminal device can effectively support the centralized management of the batteries installed in the plurality of vehicles. The work efficiency can be improved and the load of management work can be reduced.

According to the disclosed technique, the centralized management of batteries installed in a plurality of vehicles can be supported effectively. Accordingly, the load of the management work can be reduced.

### BRIEF DESCRIPTION OF THE DRAWINGS

FIG. 1 is a schematic diagram illustrating the structure of a support system that is based on a disclosed technique.

FIG. 2 is a block diagram illustrating the functional structure of a server and a terminal device.

FIG. 3 is a diagram illustrating a table of vehicle storage area information.

FIG. 4 is a diagram illustrating a table of vehicle identification information.

FIG. 5 is a diagram illustrating a vehicle storage area used to describe a support method.

FIG. 6 is a sequence diagram illustrating a flow of the entire processing of the support method.

FIG. 7 is a diagram illustrating an example of whole display.

FIG. 8 is a diagram used to describe a method of setting sub-areas.

FIG. 9 is a diagram used to describe a method of setting sub-areas.

FIG. 10 is a diagram used to describe a method of setting sub-areas.

FIG. 11 is a diagram illustrating an example of first display.

FIG. 12 is a diagram illustrating an example of second display.

FIG. 13 is a diagram illustrating an example of the second display in which a route is indicated.

FIG. 14 is a diagram illustrating an example of third display.

### DETAILED DESCRIPTION

An embodiment of a disclosed technique will be described with reference to the drawings. The embodiment is an example of the disclosed technique.

### <Support System>

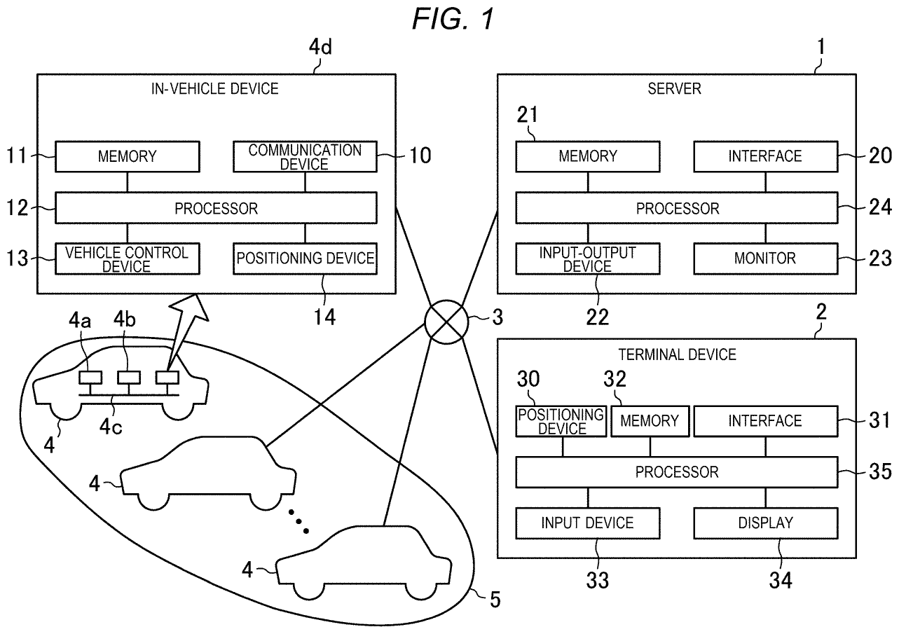

FIG. 1 illustrates the structure of a system (also simply referred to below as a support system) that is based on the disclosed technique and supports the centralized management of a plurality of batteries 4a. This support system includes a predetermined server 1 and a predetermined terminal device 2.

The server 1 and the terminal device 2 can communicate with a plurality of vehicles 4 via a network 3. The plurality of vehicles 4 are the targets supported by the support system. That is, the plurality of batteries 4a described above are the batteries 4a (in-vehicle batteries) installed in the plurality of vehicles 4, respectively. The plurality of vehicles 4 are parked in a predetermined vehicle storage area 5.

The vehicle storage area 5 is the place in which many vehicles 4 are stored closely. Specific examples of the vehicle storage area 5 are, for example, a transportation port, a transportation company, a dealer, and the like. The place in which many vehicles 4 are stored closely for a relatively long period of time can be the vehicle storage area 5.

### (Vehicle)

The vehicle 4 is, for example, an automobile, a motorcycle, or the like. Herein, the vehicle 4 is assumed to be an automobile in the embodiment. The vehicle 4 is equipped with a battery 4a, which is used as a power supply mainly for electrical components.

The battery 4a is generally a lead-acid battery that outputs a voltage of 12V. When left unattended, the battery 4a is discharged and the voltage thereof drops. Then, when the voltage drops, irreversible degradation (so-called sulfation) occurs. Accordingly, even when the battery 4a is not used, the battery 4a needs to be charged regularly to maintain an appropriate voltage.

For example, it can be determined that the battery 4a with a voltage of less than 12.6V is required to be charged. The battery 4a required to be charged needs to be charged until the voltage thereof reaches 12.6V or higher. Normally, the battery 4a needs to be fully charged (approximately 13V). It typically takes several hours to fully charge the battery 4a in the case of normal charge by, e.g., driving the engine. The support system supports centralized management of the voltages of many batteries 4a as described above.

The vehicle 4 according to the embodiment travels by driving the engine. The vehicle 4 may be an electric vehicle that travels by driving the motor or a hybrid vehicle that travels by driving both the engine and the motor. The vehicle 4 is equipped with various electrical components 4b, e.g., headlights, hazard lamps, a horn, an air conditioner, and the like, in addition to the battery 4a.

The vehicle 4 is also equipped with a controller that controls the operation of the engine (motor). That is, the vehicle 4 is equipped with the electronic devices 4b powered by the battery 4a, such as these electrical components and the controller, together with the battery 4a. The vehicle 4 has a controller area network (CAN) 4c. The battery 4a and the electronic devices 4b described above are connected to this controller area network 4c.

The vehicle 4 is also equipped with an in-vehicle device 4d that constitutes the support system. This in-vehicle device 4d is also connected to the controller area network 4c. The in-vehicle device 4d communicates with the battery 4a and the electronic devices 4b via the controller area network 4c. The in-vehicle device 4d includes a communication device 10, an in-vehicle memory 11, an in-vehicle processor 12, a vehicle control device 13, a vehicle positioning device 14, and the like.

The communication device 10 enables connection to an external network 3. That is, the vehicles 4 can communicate with external devices via a wide area network (WAN) (so-called connected car).

The in-vehicle memory 11 stores vehicle information regarding the vehicle 4 and a control program. That is, the in-vehicle memory 11 stores the vehicle identification information that enables identification of the vehicle 4. The vehicle identification information includes, e.g., a vehicle identification number (VIN), a model name, a body color, and the like. The control program is software and includes control instructions required for the vehicle 4 to receive support.

The in-vehicle processor 12 performs various types of processing about support according to the control program. For example, the vehicle control device 13 controls the battery 4a and the electronic devices 4b in response to a request from the in-vehicle processor 12. The vehicle control device 13 also acquires information (battery voltage information) about the voltage of the battery 4a using the controller area network 4c in response to a request from the in-vehicle processor 12.

The vehicle control device 13 outputs the acquired battery voltage information to the in-vehicle processor 12. The voltage value of the battery 4a is identified based on this battery voltage information. The battery voltage information may be the voltage value of the battery 4a.

The vehicle positioning device 14 is a device that can measure the position of the vehicle 4 with high accuracy, such as the global navigation satellite system (GNSS). The vehicle positioning device 14 measures the position of the vehicle 4 in response to a request from the in-vehicle processor 12, and outputs the information (vehicle position information) of the measured value to the in-vehicle processor 12. The in-vehicle processor 12 also outputs the vehicle identification information, the vehicle position information, and the battery voltage information to the terminal device 2 or the server 1 according to a command (information about an instruction) input by the terminal device 2 or the server 1.

### (Server)

The server 1 may be a high-performance and non-portable computer constituting the support system. The server 1 has a server interface 20, a server memory 21, an input-output device 22, a monitor 23, a server processor 24, and the like as hardware. The server 1 is connected to the network 3 via the server interface 20. Accordingly, the server 1 can input and output information to and from the plurality of vehicles 4 and the terminal device 2.

The server 1 also has, as software, control program that executes various types of processing of the support system and data used for the processing. The control program and data are stored in the server memory 21. The data includes vehicle information acquired from the plurality of vehicles 4. The data is stored in the server memory 21. The data stored in the server memory 21 is rewritten or deleted as necessary.

The input-output device 22 includes devices such as a keyboard and a mouse that enable the input of information to the server 1. The input-output device 22 also includes devices such as a printer that enable the output of information from the server 1. The input-output device 22 can request the server processor 24 to execute predetermined processing by inputting a command. The monitor 23 indicates the information processed by the server processor 24 in response to the command input by the input-output device 22.

The server processor 24 executes the control program according to the command input by the input-output device 22 or the command input by the terminal device 2. The server processor 24 processes various types of information including vehicle information by executing the control program.

### (Terminal Device)

The terminal device 2 may be a portable computer constituting the support system. For example, a tablet PC, a smartphone, or the like can be used as the terminal device 2. The terminal device 2 has a terminal positioning device 30, a terminal interface 31, a terminal memory 32, an input device 33, a display 34, a terminal processor 35, and the like as hardware.

The terminal device 2 is connected to the network 3 via the terminal interface 31. Accordingly, the terminal device 2 can input or output information to or from the plurality of vehicles 4 and the server 1.

The terminal positioning device 30 is a device such as the GNSS that can measure the position of the terminal device 2 with high accuracy. The terminal positioning device 30 measures the position of the terminal device 2 in response to a request from the terminal processor 35, and outputs the information (terminal position information) of the measured value to the terminal processor 35.

The terminal device 2 also has, as software, a control program that executes various types of processing of the support system and data used for the processing. The control program and data are stored in the terminal memory 32. The data includes vehicle information acquired from the plurality of vehicles 4 via the server 1. The data is stored in the terminal memory 32. The data stored in the terminal memory 32 is rewritten or deleted as necessary.

The input device 33 includes a device such as a touch pen that enables the input of information to the terminal device 2. The input device 33 can request the terminal processor 35 to execute processing by inputting a command. From the viewpoint of portability, the input device 33 is may be a touch panel. In this case, the display 34 functions as a touch panel and indicates the information processed by the processor in response to a command input by a touch pen, a fingertip, or the like. The display 34 that functions as a touch panel constitutes the input device 33.

The terminal processor 35 executes the control program based on the command input by the input device 33. The terminal processor 35 processes various types of information including vehicle information by executing the control program.

In this support system, the command input by the terminal device 2 is also output to the server 1. Then, the server processor 24 executes the control program based on the command. That is, various types of processing about support are executed by the terminal device 2 and the server 1 based on the command input by the terminal device 2. The server 1 and the terminal device 2 cooperate with each other to perform various types of processing about support.

Generally, the performance of hardware such as the memory 21 and the processor 24 of the server 1 is higher than that of the terminal device 2. The storage capacity of the memory 21 of the server 1 is also typically larger than that of the terminal device 2. Accordingly, the server 1 may perform complicated processing and the terminal device 2 may perform simple processing. The server 1 and the terminal device 2 complement each other by taking advantage of their different characteristics. This causes the server 1 and the terminal device 2 to perform various types of processing about support efficiently. A series of processes described later is an example of this.

### (Functional Structures of the Server and the Terminal Device)

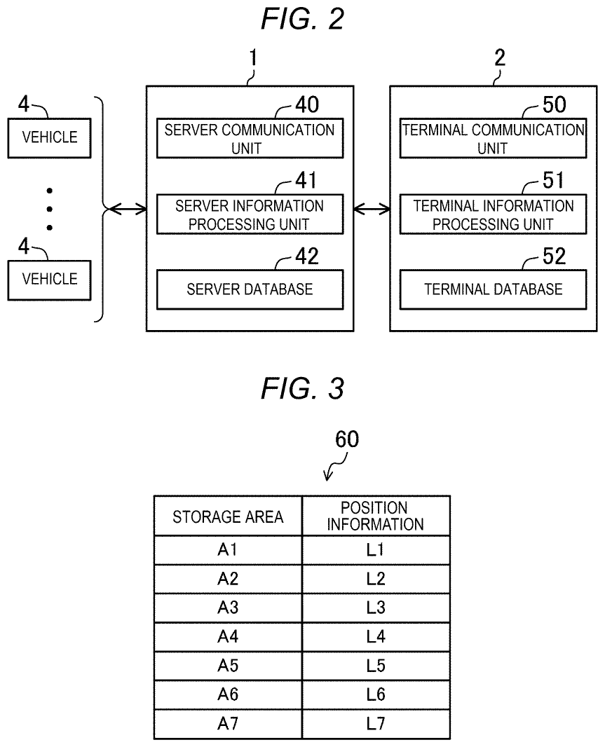

FIG. 2 illustrates the functional structures of the server 1 and the terminal device 2. The server 1 and the terminal device 2 have the functional structures. These functional structures are achieved by a combination of hardware such as a processor and software such as a control program.

The server 1 includes a server communication unit 40, a server information processing unit 41, and a server database 42 as the functional structure. The terminal device includes a terminal communication unit 50, a terminal information processing unit 51, and a terminal database 52 as the functional structure.

The server communication unit 40 communicates with the plurality of vehicles 4 and the terminal device 2 via the network 3. The server information processing unit 41 processes various types of information input through the server communication unit 40 and the information stored in the server database 42. Then, the server information processing unit 41 outputs the processed information to the plurality of vehicles 4 and the terminal device 2 through the server communication unit 40.

The server database 42 stores various types of information input through the server communication unit 40 and the information acquired by processing by the server information processing unit 41 based on the various types of information. The server database 42 stores vehicle information such as vehicle storage area information, vehicle identification information, vehicle position information, and battery voltage information.

The vehicle storage area information enables the identification of the position of the vehicle storage area 5. The vehicle storage area information includes the position information that identifies the partitioning range of the area using the latitude, the longitude, and the like. The vehicle storage area information can be acquired using a system, e.g., the GNSS.

The vehicle storage area information needs to be registered in the server database 42 in advance with this information associated with the vehicle storage areas 5 possibly subject to support. For example, the information only needs to be stored in the server database 42 by inputting the information using the input-output device 22. The vehicle storage area information is stored in a predetermined table of the server database 42.

FIG. 3 illustrates a table 60 of vehicle storage area information. The seven vehicle storage areas 5 denoted by A1 to A7 are registered in this table 60. Then, position information L1 to position information L7 of A1 to A7 are stored with the position information L1 to position information L7 associated with the vehicle storage areas 5, respectively. It should be noted that the number of pieces of vehicle storage area information stored in the table 60 in advance only needs to be one or more.

The vehicle identification information stored in the server database 42 is a collection of vehicle identification information and includes the vehicle identification information of the plurality of vehicles 4 parked in the vehicle storage area 5. Each of the in-vehicle memories 11 of the vehicles 4 stores the vehicle identification information thereof. The vehicle identification information is acquired by the server 1 from the vehicles 4 via the network 3. The vehicle identification information is temporarily stored in the predetermined table of the server database 42.

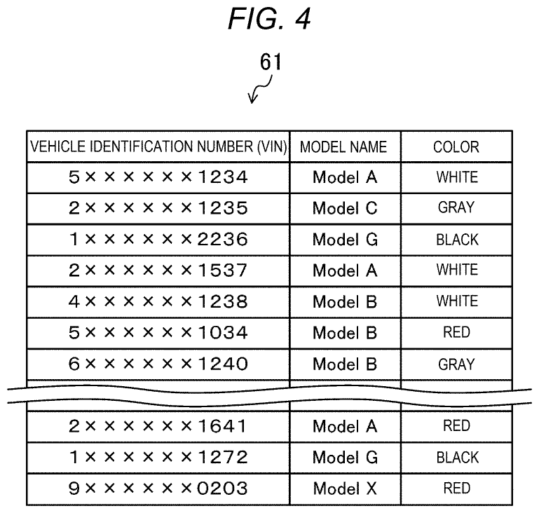

FIG. 4 illustrates a table 61 of vehicle identification information. This table 61 stores the vehicle identification information of all the vehicles 4 parked in the vehicle storage area 5. The vehicle identification information includes the vehicle identification number, the model name, the body color, and the like. These pieces of information are associated with each other.

The vehicle identification information may be registered in the table 61 in advance. At least the vehicle identification number should be registered in the table 61 while the vehicle 4 is stored in the vehicle storage area 5. For example, the vehicle identification information is input or deleted by the input-output device 22 when the vehicle 4 at the time of entrance and exit. The vehicle identification information only needs to be stored in the server database 42 for a certain period of time by this operation.

The vehicle position information stored in the server database 42 is a collection of information indicating the positions of the plurality of vehicles 4 parked in the vehicle storage area 5. Each of the vehicles 4 outputs the vehicle position information thereof to the server 1 in response to a command input from the server 1. The vehicle identification information acquired from each of the vehicles 4 is temporarily stored in the server database 42 with this information associated with the vehicle identification information of the corresponding vehicle 4.

The battery voltage information stored in the server database 42 is a collection of battery voltage information and includes the battery voltage information of the plurality of vehicles 4 parked in the vehicle storage area 5. Each of the vehicles 4 outputs the battery voltage information thereof to the server 1 in response to a command input from the server 1. The battery voltage information acquired from each of the vehicles 4 is temporarily stored in the server database 42 with this information associated with the vehicle identification information of the corresponding to vehicle 4.

The terminal communication unit 50 communicates with the server 1 via the network 3. The terminal information processing unit 51 processes various types of information input from the server 1 through the terminal communication unit 50 and the information stored in the terminal database 52. Then, the terminal information processing unit 51 outputs the processed information to the server 1 through the terminal communication unit 50. The terminal database 52 stores various types of information input through the terminal communication unit 50 and the information acquired by processing by the terminal information processing unit 51 based on the various types of information.

The terminal device 2 may be carried by the worker who performs management work. From the viewpoint of the portability of the terminal device 2, the server 1 performs the main processing in the support system according to the embodiment. The terminal device 2 acquires the minimum necessary vehicle information from the server 1 via the network 3 as necessary. As a result, a relatively small amount of vehicle information, that is, the vehicle storage area information, the vehicle identification information, the vehicle position information, the battery voltage information, and the like are temporarily stored in the terminal database 52.

The terminal device 2 is used by the worker as a tool for mainly inputting a command of processing regarding support. Accordingly, in the terminal device 2, indication by the display 34 that may also function as a touch panel is devised to facilitate the input of a command accompanied by the situation decision (details will be described later).

### <Support Method>

A support method that uses the support system described above will be described. This support method targets the plurality of vehicles 4 parked in the predetermined vehicle storage area 5. In addition, this support method supports the centralized management of the batteries 4a installed in these vehicles 4.

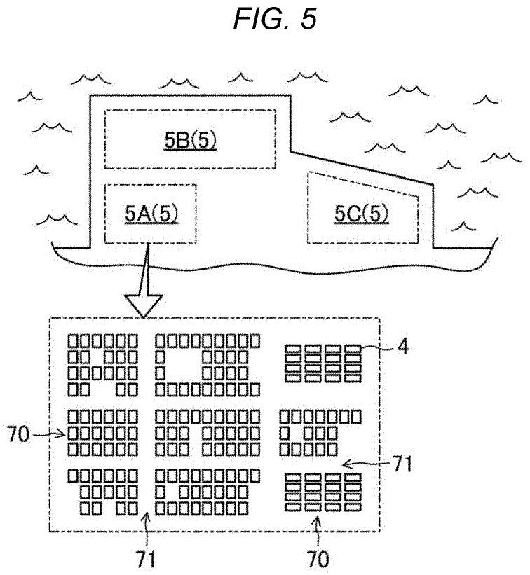

FIG. 5 illustrates an example of the vehicle storage area 5. FIG. 5 illustrates the vehicle storage area 5 in a transport port. The vehicle storage area 5 is partitioned in a vast space provided in one section of a harbor. In FIG. 5, three vehicle storage areas 5 including 5A, 5B, and 5C are partitioned. For example, several hundreds of vehicles 4 are stored in each of the vehicle storage areas 5.

As illustrated in enlarged view in FIG. 5, a plurality of parking areas 70 are further partitioned in each of the vehicle storage areas 5 so that each of the vehicles 4 can be parked in proper alignment. A runway 71 through which the vehicle 4 can pass is provided between the parking areas 70. In these parking areas 70, the vehicles 4 of various vehicle types and colors carried by ships are stored until they are handed over to transport companies.

Meanwhile, these vehicles 4 need to be maintained to keep their quality. For example, for the vehicles 4, predetermined check work such as appearance check and engine operation is performed at intervals. Along with the check work, the work for managing the voltages of the batteries 4a installed in the vehicles 4 is also performed.

That is, the vehicle 4 required to be charged is selected from the stored vehicles 4. After that, the worker goes to the place in which the vehicle 4 is parked and finds the target vehicle 4. Then, the worker charges the battery 4a along with the check work of the vehicles 4.

However, a huge number of vehicles 4 are stored in the vehicle storage area 5. Moreover, there are many vehicles 4 that are difficult to distinguish, such as the vehicles 4 of the same color and the same model or the vehicles 4 of the same model and different colors. Accordingly, the vehicle 4 required to be charged cannot be found easily among these vehicles 4. In addition, since the vehicle storage area 5 has a large space, it takes effort and time for the worker to go to the place in which there is the vehicle 4 required to be charged.

Furthermore, the charge time of the battery 4a is generally long. When the battery 4a is charged by, for example, driving the engine, it takes several hours until the voltage of the battery 4a reaches an appropriate value. Accordingly, the fact is that one worker can charge only a few vehicles a day. Such work is extremely inefficient and needs improvement.

Accordingly, this support method supports the centralized management of the batteries 4a so that such work can be performed easily and efficiently. That is, this support method includes actions for performing information acquisition processing, whole display processing, sub-area setting processing, target extraction processing, first display processing, second display processing, and guidance processing by using the support system described above. These actions support the centralized management of the batteries 4a. Details on these actions will be described later.

Here, the information acquisition processing acquires the vehicle identification information, the vehicle position information, and the battery voltage information from the vehicles 4. The whole display processing causes the terminal device 2 to indicate the positions of all the vehicles 4 parked in the vehicle storage area 5 as a map. The sub-area setting processing sets a plurality of sub-areas 80 in the vehicle storage area 5, described in detail below. The target extraction processing extracts the vehicle 4 (vehicle 4′ in need of charging) required to be charged from the plurality of vehicles 4 based on the battery voltage information.

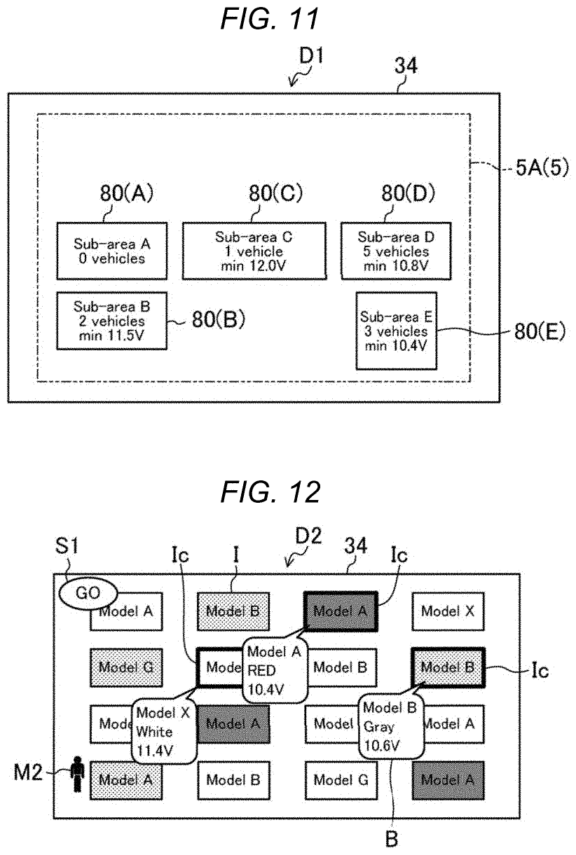

The first display processing causes the terminal device 2 to indicate first display D1 (see FIG. 11) for indicating the decision information regarding the vehicle 4′ in need of charging in each of the sub-areas 80. Then, the second display processing causes the terminal device 2 to indicate second display D2 (see FIG. 12) for displaying the vehicle identification information and the vehicle position information of the vehicle 4′ in need of charging that is parked in the management sub-area 80a when an operation for selecting the management sub-area 80a from the sub-areas 80 is performed in the terminal device 2 based on the first display D1. The guidance processing performs a guide to the vehicle 4′ in need of charging.

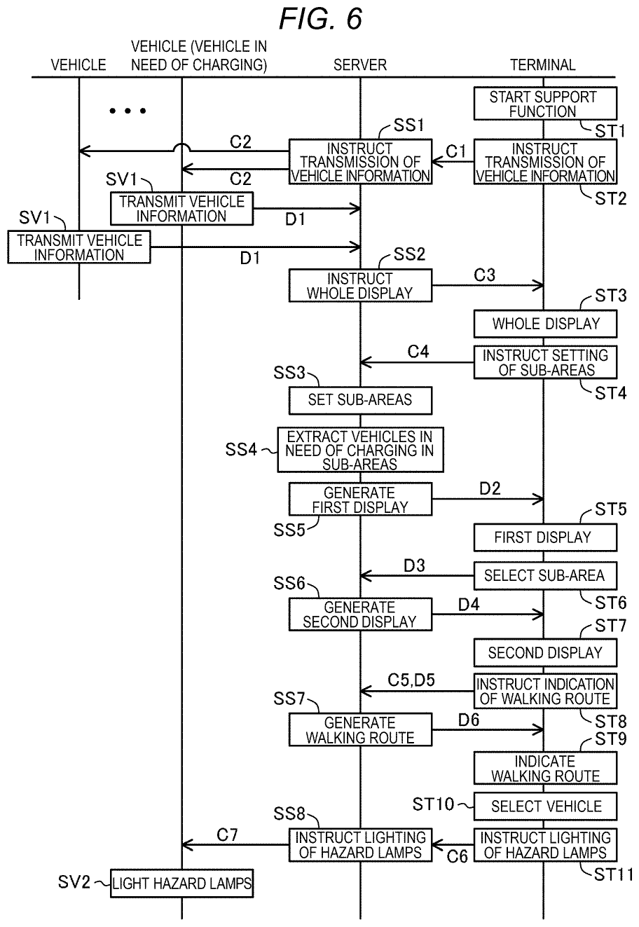

FIG. 6 illustrates a specific example of the processing described above. FIG. 6 is a sequence diagram illustrating a flow of the entire processing described above. The leftmost sequence in FIG. 6 represents a flow of the processing performed by the vehicle 4. Although there are the plurality of vehicles 4 (usually several hundreds of vehicles 4), only the vehicle 4 not required to be charged and the vehicle 4 (vehicle 4′ in need of charging) required to be charged are illustrated for convenience. The middle sequence in FIG. 6 represents a flow of the processing performed by the server 1. The rightmost sequence in FIG. 6 represents a flow of the processing performed by the terminal device 2.

As described above, the server 1 (server database 42) stores the vehicle storage area information and the vehicle identification information in advance. In this description, it is assumed that one vehicle storage area 5A of the three vehicle storage areas 5A, 5B, and 5C illustrated in FIG. 5 is subject to management. The vehicle storage area 5 subject to management is not limited to one area. A plurality of areas may be managed and any settings can be made.

First, the terminal device 2 is carried by the worker who performs management work. Here, the terminal device 2 is assumed to be a tablet PC. Then, the worker starts a predetermined application for performing support by operating the terminal device 2, specifically the display 34 (step ST1). This causes the terminal information processing unit 51 and the server information processing unit 41 of the terminal device 2 and the server 1 to start execution of a series of processes regarding support.

The worker inputs a command for instructing the transmission of the vehicle information by operating the display 34 (step ST2). This causes the terminal device 2 (specifically, the terminal information processing unit 51, this is also true in this description) to output a command C1 to the server 1 (specifically, the server information processing unit 41, this is also true in this description) so as to request the vehicles 4 to output the vehicle information (specifically, the vehicle identification information, the vehicle position information, and the battery voltage information).

Based on the command C1, the server 1 simultaneously transmits, to all the vehicles 4 parked in the vehicle storage area 5, a command C2 for instructing the transmission of the vehicle information (step SS1). It should be noted that the processing in step ST2 and the processing in step SS1 may be automatically performed by starting an application.

When the vehicles 4 receive the command C2, the in-vehicle processors 12 output vehicle information D1 including the vehicle identification information, the vehicle position information, and the battery voltage information to the server 1 (step SV1). When the vehicle identification information is registered in the server database 42 in advance, the vehicle identification information does not need to be output to the server 1.

Steps ST1 and ST2 by the terminal device 2, step SS1 by the server 1, and step SV1 by the vehicle 4 correspond to the information acquisition processing described above.

When receiving the vehicle information D1 from the vehicles 4, the server 1 outputs a command C3 for instructing whole display DT to the terminal device 2 (step SS2). When receiving the command C3, the terminal device 2 indicates the whole display DT on the display 34. Here, the whole display DT indicates the positions of all the vehicles 4 parked in the vehicle storage area 5 as a map.

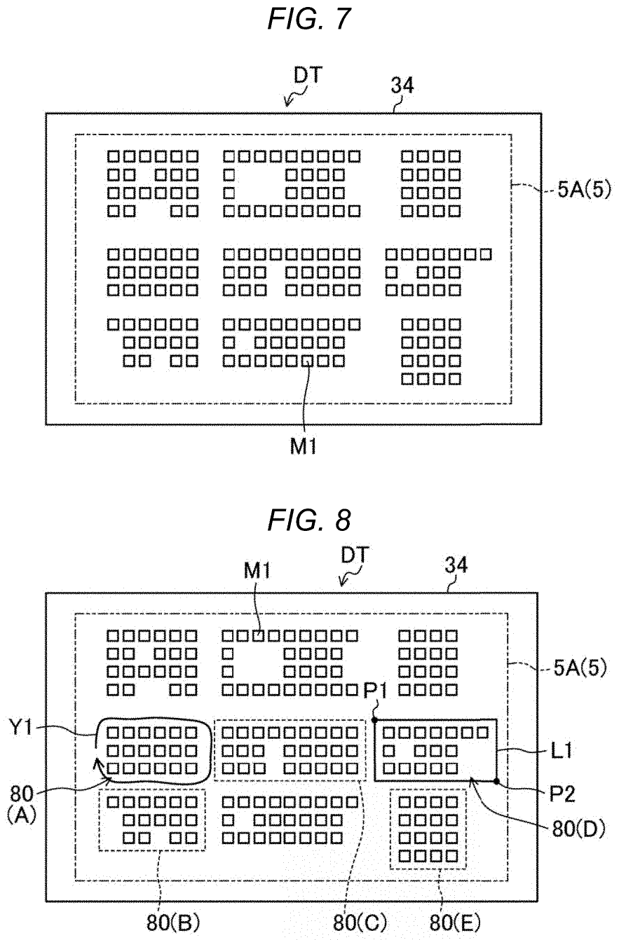

FIG. 7 illustrates an example of the whole display DT. The whole display DT indicates, as a map, the entire vehicle storage area 5 subject to management on the screen of the display 34. Then, the distribution of the vehicles 4 parked in the vehicle storage area 5 is indicated so as to correspond to the indication of the vehicle storage area 5 in the indicated vehicle storage area 5. In FIG. 7, each of rectangular marks M1 represents the vehicle 4. The shape of the mark M1 is an example.

When the whole display DT is indicated, for example, the vehicle storage area information and the vehicle position information of the vehicles 4 are transmitted from the server 1 to the terminal device 2. Based on the information, the terminal device 2 performs processing for illustrating the whole display DT on the display 34.

The whole display DT indicated on the display 34 can be enlarged and reduced. For example, the whole display DT may be enlarged or reduced by performing pinching (such as pinching with two fingers) on the display 34. This operation is effective when the display 34 is small as in a smartphone or when the vehicle storage area 5 is large.

Step ST3 by the terminal device 2 and step SS2 by the server 1 correspond to the whole display processing described above.

The worker sets the sub-areas 80 by operating the terminal device 2 based on the illustrated whole display DT. The plurality of sub-areas 80 are set in the vehicle storage area 5. The plurality of vehicles 4 parked in the vehicle storage area 5 are subdivided into smaller groups using the sub-areas 80.

Many vehicles 4 parked in the vehicle storage area 5 are subdivided arbitrarily by setting the sub-areas 80. For example, when there is an area that is clearly not subject to management, such as the area that was subject to management the day before, the area can be excluded in advance by setting the sub-areas 80. By setting the sub-areas 80, the number and the areas of the vehicles 4 subject to management can be narrowed. This improves the work efficiency.

Various methods may be used to set the sub-areas 80. FIG. 8 illustrates an example of the method (manual method) by the worker. One method encloses a sub-area 80, here five sub-areas 80 (A to E), by touching the screen of the display 34 with a fingertip or a touch pen, as indicated by an arrow line Y1. Another method indicates a rectangular frame on the screen of the display 34 and surrounds a sub-area 80 with the frame, as illustrated by a thin solid line L1. A frame with any size and any shape can be indicated at any position by specifying two diagonal points P1 and P2 on the screen. It should be noted that the frame may be circular.

The sub-areas 80 may be set in advance. For example, the sub-area information may also be registered when the vehicle storage area information is registered. Specifically, the sub-area information that enables the identification of the positions of the sub-areas 80 is stored in the server database 42 with this information associated with the vehicle storage area information. Then, the sub-areas 80 can be indicated automatically together with the whole display DT as illustrated by the dashed lines in FIG. 8.

The sub-areas 80 may be set by causing the worker to specify the number of sub-areas 80. That is, the terminal device 2 divides the vehicle storage area 5 into equal sections according to the specified number, and indicates the equally divided sections as the sub-areas 80 in the whole display DT.

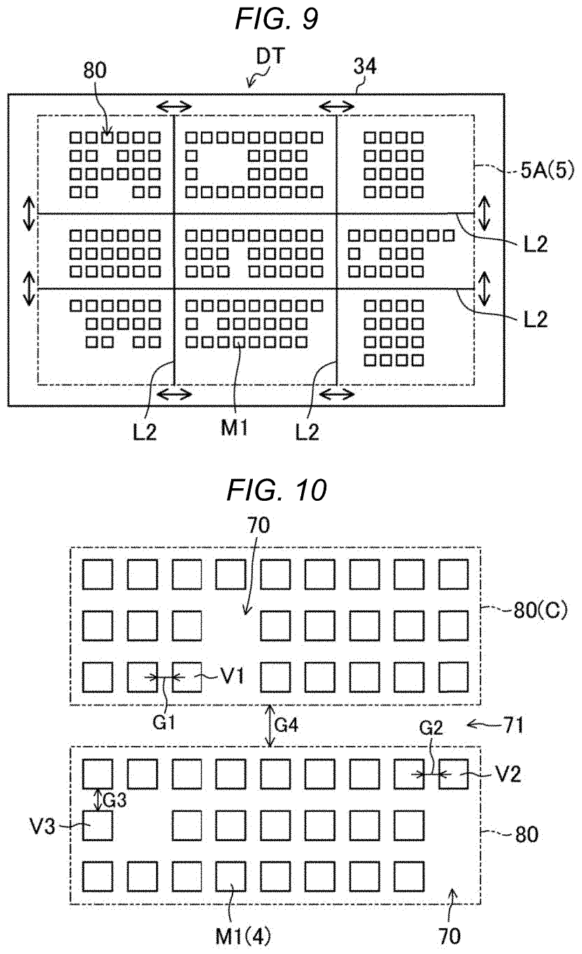

FIG. 9 illustrates the whole display DT when nine sub-areas 80 are specified. In FIG. 9, the areas of the sub-areas 80 are the same. The vehicle storage area 5 is divided in a grid pattern by straight lines (partitioning lines L2) along the latitude and the longitude. However, the shape of the vehicle storage area 5 is different. In addition, the parking positions of the vehicles 4 are also different. Accordingly, it is difficult to properly set the sub-areas 80 by simply dividing the vehicle storage area 5 that have the same area.

Accordingly, the positions of the partitioning lines L2 may be adjustable to the worker. For example, as illustrated by the arrows in FIG. 9, the worker may move the end portions of the partitioning lines L2 with reference to the whole display DT so as to appropriately set the sub-areas 80. The worker may adjust the partitioning lines L2 by moving them up, down, left, or right or tilting them.

The sub-areas 80 may be automatically set based on the close state of the vehicles 4. That is, the vehicles 4 are generally parked closely to some extent as in the parking area 70 described above in the vehicle storage area 5. Accordingly, the sub-areas 80 can be automatically set appropriately based on the close state of the vehicles 4.

A specific example thereof is illustrated in FIG. 10. FIG. 10 is an enlarged view of a part of FIG. 7. As illustrated in FIG. 5, in the vehicle storage area 5, the plurality of parking areas 70 are adjacent to each other via the runways 71. The width of the runway 71 is set to a size (for example, 3 m) that allows the vehicle 4 to pass. In contrast, the vehicles 4 are parked in a close state in the parking area 70. Accordingly, the distance between the adjacent vehicles 4 is narrow.

Accordingly, the server 1 performs processing for calculating the distance (inter-vehicle spacing) between adjacent vehicles 4 for all the vehicles 4 parked in the vehicle storage area 5. The inter-vehicle spacing here is not the spacing of the marks M1, but the actual spacing between the vehicles 4.

In this case, the vehicle 4 may have an adjacent vehicle 4 only on one side of the front, rear, left, and right sides of the vehicle 4, or a plurality of different inter-vehicle spacings may be present (for example, V1, V2, and V3 in FIG. 10). In such a case, the server 1 adopts the smallest spacing (for example, G1, G2, and G3 in FIG. 10) as the inter-vehicle spacing of the vehicle 4.

Then, the server 1 identifies a group of vehicles 4 that stop in a proximity state in which the inter-vehicle spacing is not more than a predetermined value. The parking area 70 can be automatically set as the sub-area 80 by setting a predetermined value such as, for example, 2 m in consideration of the vehicle spacings G1, G2, and G3 and an aisle width G4.

The set sub-area 80 can be reset. For example, the inside of the sub-area 80 indicated on the screen of the display 34 may be touched to make a reset. The sub-area 80 may be set by any one of the plurality of methods described above or set by combining these methods. A method other than the method described above may be used. It should be noted that five sub-areas 80 including A to E are assumed to be set in the embodiment.

When the sub-areas 80 are set by an operation of the worker, the terminal device 2 outputs a command C4 to the server 1 based on the setting (step ST4). When receiving the command C4, the server 1 performs processing for setting the sub-areas 80 in the vehicle storage area 5 as data (step SS3).

Step ST4 by the terminal device 2 and step SS3 by the server 1 correspond to the sub-area setting processing described above. When the entire sub-area setting processing is automatically performed, the whole display processing is unnecessary and can be omitted. Similarly, the processing in step ST4 by the terminal device 2 can also be omitted.

After the sub-areas 80 are set, the server 1 performs processing for extracting the vehicles 4′ in need of charging in each of the sub-areas 80 (step SS4).

Specifically, the server 1 identifies the voltage values of the batteries 4a of the vehicles 4 parked in each of the set sub-areas 80 based on the acquired battery voltage information of the vehicles 4. Then, the server 1 determines whether the batteries 4a are required to be charged based on these voltage values. For example, the server 1 determines that the batteries 4a having a voltage of less than 12.6V are required to be charged.

A reference value (a voltage value or a value corresponding to a voltage value) for determining the necessity of charging is set in the server 1 in advance. By comparison with the reference value, the server 1 extracts the vehicles 4 (vehicles 4′ in need of charging) required to be charged in each of the sub-areas 80.

Step SS4 by the server 1 corresponds to the target extraction processing described above.

The server 1 and the terminal device 2 perform the first display processing after the target extraction processing. That is, the server 1 generates the first display D1 (specifically, the data for indicating the first display D1) that indicates the decision information regarding the vehicles 4′ in need of charging (step SS5). Then, the server 1 transmits the data D2 of the generated first display D1 to the terminal device 2. When receiving the data D2 of the first display D1 from the server 1, the terminal device 2 indicates the first display D1 (See FIG. 11) on the display 34 of the terminal device 2 in each of the sub-areas 80 (step ST5).

FIG. 11 illustrates an example of the first display D1. The five set sub-areas 80 (A to E) (See FIG. 8) are indicated in the first display D1. The first display D1 indicates, as a map, the plurality of sub-areas 80 while the positional relationship between the sub-areas 80 is kept to make visual decision easy. The first display D1 also indicates the shapes of the sub-areas 80 in a simplified form, such as rectangular frames.

The sizes of the sub-areas 80 may be expressed proportionally to the actual areas of the sub-areas 80. This makes the visual identification of the sizes of the sub-areas 80 easy. The size of the sub-area 80 may be expressed proportionally to the number of vehicles 4 parked in the sub-area 80. This makes the visual identification of the number of vehicles 4 in the sub-area 80 easy. In both cases, the narrowing of the sub-areas 80 subject to management work becomes easy.

The sizes of the sub-areas 80 or the number of vehicles 4 parked may be identified by coloring the sub-areas 80 with the shades of color or different colors. This can also make the visual identification easy. It should be noted that the first display D1 indicated on the display 34 can be enlarged and reduced as in the whole display DT. Decision information regarding the vehicles 4′ in need of charging is indicated in each of the sub-areas 80 indicated in the first display D1 as the information for narrowing the sub-areas 80 subject to management work. The decision information includes the number of vehicles 4 (the number of vehicles) of the vehicles 4′ in need of charging in each of the sub-areas 80 and the lowest voltage value of the batteries 4a of the vehicles 4′ in need of charging in each of the sub-areas 80.

Specifically, the number of vehicles 4 of the vehicles 4′ in need of charging that are parked in each of the sub-areas 80 is indicated in the sub-area 80. For example, since no vehicles 4′ in need of charging are present in sub-area 80(A), the number of vehicles is indicated as “0”. Since five vehicles 4′ in need of charging are present in sub-area 80(D), the number of vehicles is indicated as “5”. The time required for management work can be easily predicted based on this indication.

In addition, the voltage value (lowest voltage value) of the battery 4a that is the lowest among the vehicles 4′ in need of charging that are parked in each of the sub-areas 80 may also be indicated in the sub-area 80. For example, since one vehicle 4′ in need of charging is present in the sub-area 80(C), the voltage value (12.0 V) of the battery 4a is indicated. The voltage value (10.8 V) of the battery 4a that is the lowest among the five vehicles 4′ in need of charging is indicated in the sub-area 80(D). The lower the voltage value, the higher the need for charging. Accordingly, the priority of each of the batteries 4a required to be charged can be determined based on this indication.

The worker can easily and efficiently narrow the sub-areas 80 subject to management work based on the first display D1 described above. That is, the vehicle storage area 5 is vast as described above. Accordingly, when the entire vehicle storage area 5 is subject to management, the worker must walk a long distance. Accordingly, the physical load on the worker is large and the work efficiency is bad.

In contrast, this support method sets a plurality of small sub-areas 80 in advance in the vehicle storage area 5. Furthermore, the support method narrows these sub-areas 80 to the sub-area 80 (management sub-area 80a) subject to management based on the decision information regarding the vehicles 4′ in need of charging. This eliminates the need for the worker to walk a long distance. This can also aggregate management work. Accordingly, the physical load on the worker can be reduced and the work efficiency is improved. The support method is also advantageous in that, when there are a plurality of workers, the support method can easily set the shares of the workers.

When the first display D1 is indicated on the display of the terminal device 2, the worker narrows the management sub-area 80a with reference to the first display D1. Then, the worker touches the management sub-area 80a indicated on the display 34. That is, the worker inputs the command for selecting the management sub-area 80a to the terminal device 2 using the display 34. Then, the terminal device 2 selects the narrowed management sub-area 80a and transmits the data D3 that identifies the management sub-area 80a to the server 1 (step ST6).

Here, it is assumed that the sub-area 80(E) has been narrowed as the management sub-area 80a. Step SS5 by the server 1 and steps ST5 and ST6 by the terminal device 2 correspond to the first display processing described above.

The server 1 and the terminal device 2 perform the second display processing after performing the first display processing. That is, the server 1 generates the second display D2 (more specifically, the data for indicating the second display D2) that indicates the vehicle identification information and the vehicle position information of the vehicles 4′ in need of charging that are parked in the management sub-area 80a (step SS6). Then, the server 1 transmits the generated data D4 of the second display D2 to the terminal device 2. When receiving the data D4 of the second display D2 from the server 1, the terminal device 2 indicates the second display D2 on the display 34 of the terminal device 2 (step ST7).

FIG. 12 illustrates an example of the second display D2. Since the sub-area 80(E) is selected as the management sub-area 80a in the first display D1 as described above, the second display D2 indicates the positions of the vehicles 4 parked in the sub-area 80(E) including the positions of the vehicles 4′ in need of charging as a map on the display 34. It should be noted that the second display D2 indicated on the display 34 can be enlarged and reduced as in the whole display DT and the first display D1.

The vehicles 4 are simplified as icons I including the front-rear and the left-right orientations. The positional relationship between the icons I of the vehicles 4 is indicated as in the actual vehicles 4 based on the vehicle position information. In addition, the model name may be indicated in each of the icons I of the vehicles 4 based on the vehicle identification information. The icons I of the vehicles 4 may be colored based on the vehicle identification information. That is, the icons I of the vehicles 4 are indicated so as to have colors correspond to the body colors of the actual vehicles 4.

The second display D2 does not indicate the vehicle identification number. The identification of the vehicle identification number requires direct access to the vehicle 4. In contrast, the vehicle type and the body color can be identified without direct access to the vehicle 4. Accordingly, the worker can determine the vehicle 4 from a distance and easily find the vehicle 4′ in need of charging.

In addition, the icon Ic of vehicle 4′ in need of charging may be highlighted, e.g., indicated with a thick line. In particular, the icon Ic of the vehicle 4′ in need of charging is set so as to have a balloon B. In addition, the model name, the body color, and the voltage value of the battery 4a of the vehicle 4′ in need of charging may be indicated in the balloon B. Alternatively or additionally, the highlighting may include a color or other differentiator indicating the vehicle most in need of charging. For example, the vehicle Ic having the lowest voltage may have a red thick line, vehicle Ic having the next lower voltage may have an orange thick line, and the vehicle Ic have the least low voltage may have a yellow thick line or these lines may have increasing thicknesses in accordance with decreasing voltage.

The model names do not need to be indicated for all the vehicles 4 parked in the management sub-area 80a, but may be indicated for the vehicle 4 adjacent to the vehicle 4′ in need of charging together with the model name of the vehicle 4′ in need of charging. Even if the model name and the body color of the vehicle 4′ in need of charging are identified, when there is the vehicle 4 with the same model name and the same body color in the management sub-area 80a, it is difficult to find the vehicle 4′ in need of charging from a distance.

In contrast, if the model name and the body color of the vehicles 4 adjacent to the vehicle 4′ in need of charging can be identified together with the model name and the body color of the vehicle 4′ in need of charging, the vehicle 4′ in need of charging can be identified by a combination of the plurality of vehicles 4. Accordingly, the vehicle 4′ in need of charging can be found even from a distance. At least one vehicle 4, adjacent to the vehicle 4′ in need of charging, for which model name is indicated is sufficient. Since the amount of indication is reduced as compared with the case in which all the vehicles 4 parked in the management sub-area 80a are indicated, the load of information processing is reduced and the visibility is improved advantageously.

The model name may be indicated when the second display D2 is enlarged beyond a predetermined size to insure sufficient readability while avoiding confusing the worker. The model name may be difficult to visually recognize if the display 34 indicates the entire management sub-area 80a when, for example, the management sub-area 80a is large or there are many vehicles 4 parked in the management sub-area 80a.

In such cases, the model names are not indicated. The second display D2 may be difficult to see when a large number of small model names are indicated. In contrast, if model names are indicated when the second display D2 is enlarged beyond a predetermined size, the model name can be visually recognized and the second display D2 becomes easy to see.

The server 1 and the terminal device 2 perform the guidance processing when needed by the worker after performing the second display processing. That is, the guidance processing is not essential in the support method. The guidance processing is performed when the worker asks for guidance to the vehicle 4′ in need of charging and enters the command for that purpose.

Specifically, as illustrated by a mark M2 in FIG. 12, the current position of the worker is indicated in the second display D2. Since the worker has the terminal device 2, the current position of the worker can be identified in real time based on the terminal position information. The terminal device 2 indicates the mark M2 in the second display D2 while the second display D2 is indicated. The mark M2 moves in response to changes in the current position of the worker.

The guidance processing calculates the optimum route (walking route) from the terminal device 2 to the vehicle 4′ in need of charging based on the vehicle position information of the vehicle 4′ in need of charging and the terminal position information. Then, the guidance processing indicates the route in the second display D2.

As illustrated in FIG. 12, a button S1 for performing the guidance processing is indicated in the second display D2. When the worker touches the button S1, the terminal device 2 outputs a command C5 for instructing the indication of the route and data D5 of the terminal position information to the server 1 (step ST8).

When receiving the data D5 and the command C5, the server 1 calculates the optimum route for going around these vehicles 4′ in need of charging based on the vehicle position information of the vehicles 4′ in need of charging that are parked in the management sub-area 80a and the input terminal position information. After calculating the route, the server 1 outputs the data D6 of the route to the terminal device 2 (step SS7).

The route can be, for example, the route for going around the vehicles 4′ in need of charging in ascending order of the voltage values of the batteries 4a. This route enables the battery 4a that is likely to suffer irreversible degradation to be charged first. Accordingly, more appropriate centralized management of the batteries 4a can be performed.

The route can also be the route for going around the vehicles 4′ in need of charging in the shortest distance. This route can minimize the walking amount of the worker. Accordingly, the effort and travel time of the worker can be reduced.

These routes may be selected by the worker. For example, after the worker touches the button, the display 34 indicates the display (route selection display) for selecting one of the route for going around the vehicles 4′ in need of charging in ascending order of the voltage values of the batteries 4a and the route for going around the vehicles 4′ in need of charging in the shortest distance. Then, after the worker selects one of these routes in the route selection display, the terminal device 2 outputs the information to the server 1 together with the terminal position information D5 and the command C5.

When receiving the data D6 of the route, the terminal device 2 indicates the route based on the data D6 in the second display D2 indicated on the display 34 (step ST9).

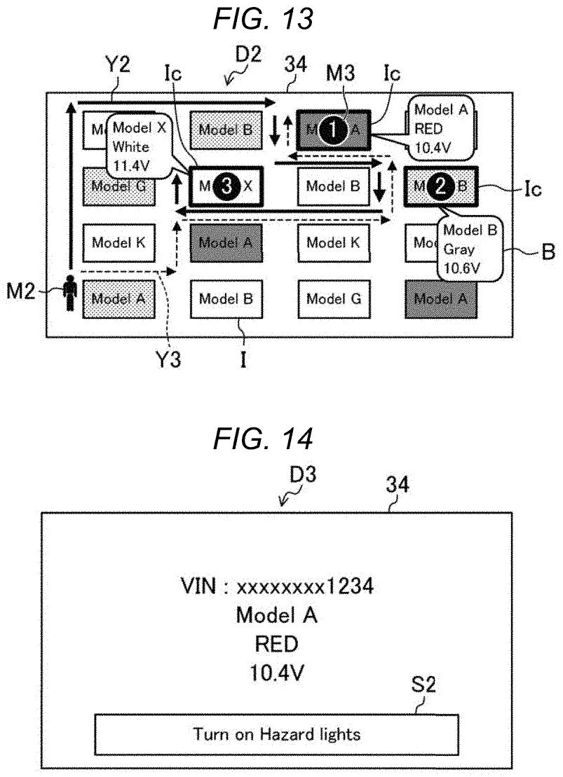

FIG. 13 illustrates the second display D2 in which the route is indicated. FIG. 13 indicates the route for going around the vehicles 4′ in need of charging in ascending order of the voltage values of the batteries 4a using thick arrows Y2. Marks M3 indicating the order of go-around are indicated in the icons Ic of vehicles 4′ in need of charging. For example, there are three vehicles 4′ in need of charging in the management sub-area 80a illustrated in FIG. 13. Among these vehicles, the vehicle 4′ in need of charging that is disposed in the top row has the lowest voltage value of the battery 4a. Accordingly, the mark M3 representing 1 is indicated in the icon Ic of the vehicle 4′ in need of charging.

The route for going around the vehicles 4′ in need of charging is illustrated in the second display D2 by the arrows Y2 along the route and the marks M3 representing the order of go-around. The worker can easily grasp the route visually. Accordingly, the work efficiency is improved.

Dashed arrows Y3 in FIG. 13 represent an example of the route for going around the vehicles 4′ in need of charging in the shortest distance. When the worker selects the route for going around the vehicles 4′ in need of charging in the shortest distance, the route indicated by the dashed arrows Y3 is indicated as a thick solid line. The order of go-around will be changed accordingly.

When the second display D2 is indicated on the display 34 of the terminal device 2, the worker selects the vehicle 4′ in need of charging that is subject to management based on the second display D2. For example, the worker touches the icon Ic or the balloon B of the vehicle 4′ in need of charging in the second display D2 illustrated in FIG. 12 or 13.

Then, the terminal device 2 selects the vehicle 4′ in need of charging and indicates, on the display 34, the third display D3 in which the vehicle information of the vehicle 4′ in need of charging is indicated. (step ST10). FIG. 14 illustrates the screen of the display 34 on which the third display D3 is indicated.

FIG. 14 illustrates the third display D3 when the vehicle 4′ in need of charging that is disposed in the top row in FIG. 12 or 13 is selected. The third display D3 indicates, as the vehicle information of the vehicle 4′ in need of charging, the vehicle identification number, the model name, the body color, and the voltage value of the battery 4a installed in the vehicle 4′ in need of charging.

When the screen indicating the third display D3 is touched, the terminal device 2 indicates the original screen of the second display D2. Accordingly, the worker can switch the display between the second display D2 and the third display D3 as necessary. The worker can check the vehicle information of the selected vehicle 4′ in need of charging based on the third display D3. This improves the work efficiency because the vehicle 4′ in need of charging can be identified more easily.

The third display D3 further indicates a button S2 for lighting the hazard lamps. When this button S2 is touched, the terminal device 2 outputs, to the server 1, a command C6 for lighting the hazard lamps of the identified vehicle 4′ in need of charging (step ST11). When receiving the command C6, the server 1 outputs a command C7 for lighting the hazard lamps to the corresponding vehicle 4′ in need of charging (step SS8).

When receiving the command C7, the vehicle 4′ (the in-vehicle device 4d) in need of charging lights the hazard lamps (step SV2). Since the hazard lamps light, the worker can easily find the vehicle 4′ in need of charging that is subject to management.

The horn may be operated at the same time with the lighting of the hazard lamps or instead of the lighting of the hazard lamps. This can also easily find the vehicle 4′ in need of charging. It should be noted that the terminal device 2 may output the command for lighting the hazard lamps and/or horn directly to the specified vehicle 4′ in need of charging without intervention of the server 1.

When finding the vehicle 4′ in need of charging that is subject to management, the worker performs the charging work of the battery 4a together with the check work of the vehicle 4′ in need of charging. The efficiency is improved because the check work and the charging of the battery 4a can be performed at the same time.

The battery 4a may be charged through normal charging by driving the engine or quick charging using a dedicated charger. The normal charging takes a long time, but the quick charging takes only a short time.

In the case of the normal charging by driving the engine, the engine may be started by directly operating the vehicle 4 or the engine may be started by remote control. For example, the worker requests the terminal device 2 to start the engine by operating the display 34. This operation causes the terminal device 2 to instruct the vehicle 4′ in need of charging to start the engine via the server 1 or directly. The vehicle 4′ in need of charging starts the engine based on this instruction.

Since the worker directly starts the engine while checking the vehicle 4, even if a trouble occurs, the worker can immediately address it. In addition, since the worker can check the state of the vehicle 4′ in need of charging and the surrounding state of the vehicle 4′ in need of charging, the worker can check the possibility of occurrence of a trouble after starting the engine. Accordingly, the worker can secure the safety at the time of charging the battery 4a.

The engine may be stopped automatically by remote control when the stable start of the engine and the safety after the start of the engine can be confirmed. For example, after the start of the engine, the server 1 periodically acquires the battery voltage information from the vehicle 4′ in need of charging. Then, when the voltage value of the battery 4a becomes a predetermined value or higher, the server 1 instructs the vehicle 4′ in need of charging to stop the engine. The vehicle 4′ in need of charging stops the engine based on the instruction.

Then, the worker can start the management work of the next vehicle 4′ in need of charging without waiting for the completion of the charging work of the battery 4a. The work efficiency is improved because the work time for each vehicle can be shortened.

As described above, according to the support method disclosed in the embodiment, even if there are many vehicles 4 subject to management, these vehicles 4 can be efficiently narrowed to the vehicles 4 actually required to be supported. Accordingly, the work efficiency of the centralized management of the batteries 4a is improved and the work load can be reduced.

The battery 4a can be charged while the vehicle 4 is checked directly. Accordingly, since the battery 4a can be charged at the same time with the check work of the vehicle 4, the work efficiency is excellent. The time for the charging work of the battery 4a can also be shortened. The safety can also be secured. As described above, the disclosed support method can achieve the effective support for the centralized management of the batteries 4a installed in the plurality of vehicles 4.

The disclosed technique is not limited to the embodiment described above, but also includes various other structures.

For example, the embodiment described above illustrates an example in which the terminal device 2 communicates with the plurality of vehicles 4 via the server 1. However, the terminal device 2 may directly communicate with the plurality of vehicles 4 without intervention of the server 1.

There may be a plurality of terminal devices. Then, the centralized management of batteries can be performed more efficiently by a plurality of workers. In particular, embodiments provide improved interfaces for determining which vehicles need charging and how to locate those vehicles. Sub-areas may be displayed showing a number of vehicles and/or minimum voltage for the vehicle having a lowest charge within that sub-area. Once a sub-area having vehicles that need charging is selected as a management sub-area, by providing an interface in which certain details for only those vehicles needing charging are displayed, may be only after a size of the management sub-area is sufficiently large to allow viewability of these details, embodiments allow ready determination, identification, and location of those vehicles that need charging from among numerous vehicles that to be maintained, increasing efficiency.

### DESCRIPTION OF REFERENCE SIGNS AND NUMERALS

1: server
2: terminal device
3: network
4: vehicle
4′: vehicle in need of charging
4a: battery
5: vehicle storage area
80: sub-area
80a: management sub-area
D1: first display
D2: second display
D3: third display

1. A method of supporting centralized management of batteries installed in a plurality of vehicles parked in a predetermined vehicle storage area, the method comprising:
acquiring, from the plurality of vehicles, vehicle information including vehicle identification information that enables identification of the plurality of vehicles, vehicle position information that enables identification of positions of the plurality of vehicles, and battery voltage information regarding voltages of the batteries;
setting a plurality of sub-areas in the vehicle storage area;
extracting at least one vehicle in need of charging, from the plurality of vehicles based on the battery voltage information;
causing a predetermined terminal device to indicate first display that indicates decision information regarding the at least one vehicle in need of charging in each of the plurality of sub-areas; and
causing the terminal device to indicate second display that indicates the vehicle identification information and the vehicle position information regarding the at least one vehicle in need of charging in a management sub-area selected from the plurality of sub-areas when a predetermined operation is performed via the predetermined terminal device based on the first display.

2. The method according to claim 1,
wherein the decision information includes a lowest voltage value of the battery among the at least one vehicle in need of charging that is parked in a single sub-area of the plurality of sub-areas, and
the lowest voltage value is indicated in each of the plurality of sub-areas of the first display.

3. The method according to claim 2,
wherein the decision information includes a number of the at least one vehicle in need of charging that is parked in the single sub-area of the plurality of sub-areas and the number of the at least one vehicle in need of charging is indicated in each of the plurality of sub-areas of the first display.

4. The method according to claim 3,
wherein, when the terminal device displays the second display, the terminal device displays, as a map, positions of the vehicles parked in the management sub-area and the position of the at least one vehicle in need of charging, and
displays the vehicle identification information of a vehicle of the plurality of vehicles that is adjacent to the at least one vehicle in need of charging together with the vehicle identification information of the at least one vehicle in need of charging.

5. The method according to claim 4,
wherein, when the terminal device displays the second display, the terminal device indicates, as a map, the positions of the vehicles parked in the management sub-area and the position of the at least one vehicle in need of charging,
terminal position information that enables identification of a position of the terminal device is acquired from the terminal device, and
when a predetermined operation is performed in the terminal device, a route from the terminal device to the at least one vehicle in need of charging is calculated based on the vehicle position information of the at least one vehicle in need of charging and the terminal position information, and the route is indicated in the second display.

6. The method according to claim 5,
wherein the terminal device indicates, as a map, positions of all the plurality of vehicles parked in the vehicle storage area, and
at least one of the sub-areas is set by operating the terminal device based on the indicated positions.

7. The method according to claim 5,
wherein a distance between each of all the plurality of vehicles parked in the vehicle storage area and a vehicle of the plurality of vehicles that is adjacent to each of all the plurality of vehicles parked in the vehicle storage area is calculated, and
at least one of the plurality of sub-areas is set by identifying a group of vehicles of the plurality of vehicles stopped in a proximity state in which the distance is not more than a predetermined value.

8. The method according to claim 1,
wherein the decision information includes the number of the at least one vehicle in need of charging that is parked in the single sub-area of the plurality of sub-areas and the number of the at least one vehicle in need of charging is indicated in each of the plurality of sub-areas of the first display.

9. The method according to claim 8,
wherein, when the terminal device indicates the second display, the terminal device indicates, as a map, positions of the vehicles parked in the management sub-area and the position of the at least one vehicle in need of charging, and
indicates the vehicle identification information of a vehicle of the plurality of vehicles that is adjacent to the at least one vehicle in need of charging together with the vehicle identification information of the at least one vehicle in need of charging.

10. The method according to claim 9,
wherein, when the terminal device indicates the second display, the terminal device indicates, as a map, the positions of the vehicles parked in the management sub-area and the position of the at least one vehicle in need of charging,
terminal position information that enables identification of a position of the terminal device is acquired from the terminal device, and
when a predetermined operation is performed in the terminal device, a route from the terminal device to the at least one vehicle in need of charging is calculated based on the vehicle position information of the at least one vehicle in need of charging and the terminal position information, and the route is indicated in the second display.

11. The method according to claim 10,
wherein the terminal device indicates, as a map, positions of all the plurality of vehicles parked in the vehicle storage area, and
at least one of the sub-areas is set by operating the terminal device based on the indicated positions.

12. The method according to claim 10,
wherein a distance between each of all the plurality of vehicles parked in the vehicle storage area and a vehicle of the plurality of vehicles that is adjacent to each of all the plurality of vehicles parked in the vehicle storage area is calculated, and
at least one of the plurality of sub-areas is set by identifying a group of vehicles of the plurality of vehicles stopped in a proximity state in which the distance is not more than a predetermined value.

13. The method according to claim 1,
wherein, when the terminal device indicates the second display, the terminal device indicates, as a map, positions of the vehicles parked in the management sub-area and the position of the at least one vehicle in need of charging, and
indicates the vehicle identification information of a vehicle of the plurality of vehicles that is adjacent to the at least one vehicle in need of charging together with the vehicle identification information of the at least one vehicle in need of charging.

14. The method according to claim 13,
wherein, when the terminal device indicates the second display, the terminal device indicates, as a map, the positions of the vehicles parked in the management sub-area and the position of the at least one vehicle in need of charging,
terminal position information that enables identification of a position of the terminal device is acquired from the terminal device, and
when a predetermined operation is performed in the terminal device, a route from the terminal device to the at least one vehicle in need of charging is calculated based on the vehicle position information of the at least one vehicle in need of charging and the terminal position information, and the route is indicated in the second display.

15. The method according to claim 14,
wherein the terminal device indicates, as a map, positions of all the plurality of vehicles parked in the vehicle storage area, and
at least one of the sub-areas is set by operating the terminal device based on the indicated positions.

16. The method according to claim 1,
wherein, when the terminal device indicates the second display, the terminal device indicates, as a map, the positions of the vehicles parked in the management sub-area and the position of the at least one vehicle in need of charging,
terminal position information that enables identification of a position of the terminal device is acquired from the terminal device, and
when a predetermined operation is performed in the terminal device, a route from the terminal device to the at least one vehicle in need of charging is calculated based on the vehicle position information of the at least one vehicle in need of charging and the terminal position information, and the route is indicated in the second display.

17. The method according to claim 1,
wherein the terminal device indicates, as a map, positions of all the plurality of vehicles parked in the vehicle storage area, and
at least one of the sub-areas is set by operating the terminal device based on the indicated positions.

18. The method according to claim 1,
wherein a distance between each of all the plurality of vehicles parked in the vehicle storage area and a vehicle of the plurality of vehicles that is adjacent to each of all the plurality of vehicles parked in the vehicle storage area is calculated, and
at least one of the plurality of sub-areas is set by identifying a group of vehicles of the plurality of vehicles stopped in a proximity state in which the distance is not more than a predetermined value.

19. A server that supports centralized management of batteries installed in a plurality of vehicles parked in a predetermined vehicle storage area, the server comprising:
an interface that enables predetermined vehicle information to be input to and output from the plurality of vehicles and a predetermined terminal device via a network;
a memory that stores the predetermined vehicle information and a predetermined control program; and
a processor that processes the vehicle information by executing the control program,
wherein the vehicle information includes vehicle storage area information that enables identification of a position of the vehicle storage area, vehicle identification information that enables identification of the plurality of vehicles, vehicle position information that enables identification of positions of the plurality of vehicles, and battery voltage information regarding voltages of the batteries,
the processor performs, in cooperation with the terminal device, processing for acquiring the vehicle identification information, the vehicle position information, and the battery voltage information by requesting the plurality of vehicles to output the vehicle identification information, the vehicle position information, and the battery voltage information based on a command input from the terminal device,
processing for setting a plurality of sub-areas in the vehicle storage area based on the vehicle storage area information,
processing for extracting at least one vehicle in need of charging from the plurality of vehicles based on the battery voltage information,
processing for causing the terminal device to indicate first display that indicates decision information regarding the at least one vehicle in need of charging in each of the plurality of sub-areas, and
processing for causing the terminal device to indicate second display that indicates the vehicle identification information and the vehicle position information regarding the at least one vehicle in need of charging in a management sub-area selected from the plurality of sub-areas when a predetermined command is input from the terminal device.

20. A terminal device that supports centralized management of batteries installed in a plurality of vehicles parked in a predetermined vehicle storage area, the terminal device comprising:
an interface that enables predetermined vehicle information to be input to and output from a predetermined server via a network;
a memory that stores the vehicle information and a predetermined control program; and
a processor that processes the vehicle information by executing the control program;
a display that indicates information processed by the processor; and
a device capable of inputting a command for requesting the processor to perform predetermined processing,
wherein the vehicle information includes vehicle storage area information that enables identification of a position of the vehicle storage area, vehicle identification information that enables identification of the plurality of vehicles, vehicle position information that enables identification of positions of the plurality of vehicles, and battery voltage information regarding voltages of the batteries,
the processor performs, in cooperation with the server, processing for acquiring the vehicle identification information, the vehicle position information, and the battery voltage information by requesting the plurality of vehicles to output the vehicle identification information, the vehicle position information, and the battery voltage information based on the command input from the device,
processing for setting a plurality of sub-areas in the vehicle storage area based on the vehicle storage area information,
processing for extracting at least one vehicle in need of charging from the plurality of vehicles based on the battery voltage information,
processing for causing the display to indicate first display that indicates decision information regarding the at least one vehicle in need of charging in each of the plurality of sub-areas, and
processing for causing the display to indicate second display that indicates the vehicle identification information and the vehicle position information regarding the at least one vehicle in need of charging in a management sub-area selected from the plurality of sub-areas when the device inputs a predetermined command based on the first display.
